(19) United States
(12) Patent Application Publication
(10) Pub. No.: US 2005/0042391 A1
(43) Pub. Date: Feb. 24, 2005

(54) Method of making a patterned optical element

(76) Inventors: Timothy George Ryan, Redcar (GB); Thomas Grierson Harvey, Redcar (GB)

Correspondence Address: JACOBSON HOLMAN PLLC, 400 SEVENTH STREET N.W., SUITE 600, WASHINGTON, DC, 20004, US

(21) Appl. No.: 10/501,212

(22) PCT Filed: Jan. 20, 2003
(86) PCT No.: PCT/GB03/00239

(30) Foreign Application Priority Data
Jan. 18, 2002 (GB) 0201132.8

(51) Int. Cl. C09K 19/00

(52) U.S. Cl. 428/1.1

(57) ABSTRACT

A method for the manufacture of patterned optical elements such as retarders or liquid crystal elements for use in optical retarders is described comprising the steps of forming an alignment layer comprising a spatially patterned monograting-like surface relief microstructure formed into a suitable receptive material; laying down a coating material onto the alignment layer which exhibits an alignable LC phase; solidifying the coating material layer to fix the alignment established during the LC phase. Patterned optical elements such as retarders or liquid crystal elements for use in optical retarders are also described.

The present invention relates to an improved process for the manufacture of patterned optical elements, such as optical retarders for use in such applications as, for example, in polarisation conversion optical systems or LCD projectors and in three-dimensional autostereoscopic displays, and to patterned optical retarders or optically active elements for such patterned optical retarders fabricated by the process.

It is known to manufacture patterned optical retarders by applying a polymerisable liquid crystal (LC) material to a suitable substrate, aligning the LC layer to a suitable pattern whilst in the LC state, and curing the LC layer to lock in the alignment. The LC layer may be oriented for example by application of an external force (eg electrical or magnetic) or by rubbing the substrate beforehand, which is found to introduce properties to the substrate surface such as to encourage alignment.

The suitably aligned LC layer forms the optically active element of the retarder device, which can then be retained on the original substrate, transferred onto another substrate, given suitable surface treatments and/or used in conjunction with other suitable layers to form a device of desired properties.

European patent 89200427 (Phillips, filed 22.02.89) discloses a method of manufacturing a laminated optical element using a polymerisable liquid crystal (LC) material. The LC layer is oriented by means of an external force or by rubbing the substrate beforehand. Also disclosed are various methods of physically patterning the LC layer, for example by depositing the LC material onto a surface with the negative of the desired pattern, orienting the LC material by means of an external force, polymerising the LC to fix the orientation and then removing the LC layer onto another substrate. Another method disclosed is the patterning of the LC layer by irradiating it through a mask so as to polymerise only selected regions of the LC.

European patent 0887 667 (Sharp Laboratories of Europe) discloses a method of making a patterned retarder by polymerising birefringent material aligned on a single alignment layer, selectively rubbed in two different directions. The method includes rubbing of an alignment layer uniformly in the first direction, masking with a mask to reveal a second region of the alignment layer and rubbing it through the mask in the second direction, removing the mask, disposing on the alignment layer a layer of birefringent material whose optical axis is aligned by the alignment layer, and fixing the optical axis of the birefringent layer.

U.S. Pat. No. 5861931 (Sharp) discloses a method of making a patterned polarising optical element using photocured liquid crystal material and the use of these elements as a latent parallax barrier in a 3D autostereoscopic display. Odd and even pixels of the LCD display create different images for left and right eyes. The parallax barrier attached to the display artificially restricts the zone where each eye sees its own image. The brain then creates the 3D image.

U.S. Pat. No. 6 222 672 (Sharp) discloses an imaging system with improved achromatic bandwidth. It describes a method of correction of chromatic dispersion in patterned retarder elements in reactive mesogen (RM) made by the multi rubbing technique discussed earlier. Such a patterned retarder includes first patterned retarder regions of half-wave plates having their optical axes oriented at equal but opposite angles followed by an additional half wave plate element with its optical axis at +/−67.5 degree to the first polarisation axis. The patent does not give any details of retarder fabrication, except clear indication (column 9) that it is made of photocurable liquid crystal RM257 (Merck) patterned by photolithography.

EP 0689 084 discloses a linearly photopolymerisable material which may be used as a patterned alignment layer for alignment of birefringent materials. However, in order to produce a retarder having regions of different retarder orientations, two or more photolithographic steps are required in order to expose the linearly photopolymerisable alignment material. These photolithographic steps must be correctly registered with each other, which adds to the complexity of the process and reduces pitch tolerance of the patterned retarder.

The present invention relates in particular to a method for the manufacture of patterned optical retarders which relies upon the aligning properties of a substrate layer onto which a suitable coating material exhibiting an LC phase, such as a polymerisable liquid crystal (LC) material, is applied, and aligned to a suitable pattern whilst in the LC state, and cured or otherwise solidified to lock in the alignment. It is primarily an alternative to systems based on the use of a single alignment layer, selectively rubbed in two different directions to produce an alignment pattern, such as described in European patent 0887667. Such methods involve multiple steps in the preparation of the alignment layer, particularly when a complex shape is involved, so that the process is laborious and slow and does not lend itself to rapid manufacture and in particular to continuous manufacturing processes.

In addition to the known methods of aligning a polymerisable liquid crystal layer to produce patterned retarder elements as above described, a number of other alignment methods are known generally in relation to liquid crystal devices. A number of sources disclose alignment of liquid crystals on microgrooved or microstructured surfaces. For example “Control of liquid crystal alignment using stamped morphology method” by E. S. Lee et al in Japanese J. Appl. Phys, Vol 32, Pp L1436-L1438 (1993) describes a method of single domain alignment of liquid crystals on an optical alignment polymer layer coated on a heat curable resin layer having microgrooves. U.S. Pat. No. 5,917,570 (DERA) describes the use of surface relief bigratings made in photoresist to align liquid crystal materials in a display device. It also mentions that the grating surface can be formed by embossing.

However, it has not been suggested that these methods could be applied in relation to a polymerisable liquid crystal; nor do they relate to the manufacture of patterned retarder elements.

It is an object of the present invention to provide an improved process for the manufacture of patterned optical elements, such as optical retarders, which mitigates some or all of the above disadvantages.

It is a particular object of the present invention to provide an improved process for the manufacture of patterned optical elements such as optical retarders based on prior alignment on a single alignment layer substrate which mitigates some or all of the disadvantages associated with conventional techniques wherein a pattern is applied to the alignment layer by rubbing.

It is a particular object of the present invention to provide an improved process for the manufacture of patterned optical elements such as optical retarders which lends itself to the manufacture of retarders of complex shapes and/or to the rapid and convenient manufacture of retarders in quantity and in particular by continuous processes.

Thus, according to a first aspect of the present invention, a method for the manufacture of a patterned optical element, such as but not limited to an optical retarder, comprises the steps of:
forming an alignment layer comprising a spatially patterned periodic surface relief microstructure formed into a suitable receptive material;
laying down a coating material that exhibits a liquid crystal phase onto the alignment layer enabling alignment of the coating material with the microstructure of the alignment layer;
forming the coating material into a solid film such that the molecular alignment between film and alignment layer is substantially preserved.

The present invention is thus a method of fabrication that substantially reduces the number of technological stages, the complexity and the operational tolerances of fabrication of broad wavelength band patterned optical elements with improved achromatic performance made of photopolymerisable liquid crystals or other similar materials exhibiting a liquid crystal phase. A further advantage of the method is that the regions of the patterned optical element are generally more clearly defined than using previous methods.

In essence, the method comprises only three basic steps.

First, a spatially patterned periodic, for example monograting-like, surface relief microstructure is fabricated whose purpose is to align the coating material that exhibits a liquid crystal phase into the desired pattern for the patterned optical retarder or other optical element when it is in the said liquid crystal phase. The direction of the microgrooves in the surface relief microstructure is defined by the design of the patterned optical element, being the same within one region or zone where the orientation should be in one direction and different in other regions or zones where the orientation should be in a different direction.

The surface relief microstructure is fabricated in any suitably receptive material to form an alignment layer. This layer may be first deposited on a suitable supporting substrate or may integrally form such a supporting substrate. This substrate may comprise the substrate eventually used in the device or a part thereof, or the optically active aligned LC layer may subsequently be transferred to an alternative substrate material.

Second, a suitable coating material that exhibits a liquid crystal phase is coated on top of the surface relief pattern. With the coating layer in the LC state, interactions between the liquid crystal phase and the surface relief pattern result in an ordered alignment of the coating material through the thickness of the coated film. The optical axis of different regions of the coating material is determined by the direction of the microgrooves of the surface relief structure beneath it.

The third stage is the solidification of the coating layer. This is done such that the molecular alignment between coating layer and alignment layer is preserved to some substantive degree. This locks in its alignment so as to produce a layer adapted to serve as the optically active basis of the retarder or other optical element.

Where used herein, references to a coating material that exhibits a liquid crystal phase crystal are to be construed broadly with regard to the three stages of the process described herein, to refer to any suitable material for the process, displaying liquid-crystal-like behaviour by being able to be deposited onto the alignment layer so as to enter a liquid-crystal-like alignable phase whereby the layer of material becomes aligned as above described under influence of interactions between the coating material and the surface relief pattern of the alignment layer, and being subsequently transformable to a solid phase to lock the alignment pattern in at least sufficiently to produce the desired optical effect.

Any materials, including combinations and mixtures of materials, exhibiting this behaviour can be considered, including without limitation conventional thermotropic and lyotropic liquid crystals, polymer dispersed liquid crystals, other anisotropic materials capable of exhibiting an alignable LC-like phase, and mixtures of liquid crystals with other materials provided the alignable LC phase is preserved. A particular example of the last includes dispersions of secondary materials such as nanoparticles in liquid crystals. In such combinations the liquid crystal has both an optical effect and an alignment effect on that nanoparticles, giving an enhanced overall (optical) effect.

The coating material may be deposited as a liquid crystal. Alternatively the coating material may be deposited in some other form and transformed to a liquid crystal phase in situ, for example by application of heat, by applying the coating in solution and removing solvent to the point where a transformation to LC-like behaviour occurs, or by any other method.

Any known solidification process that preserves the alignment pattern in at least sufficiently to produce the desired optical effect is suitable. For example the coating material may be a lyotropic liquid crystal, the solidification step comprising removal of solvent to such point that a solid phase is formed from the coating layer. Alternatively, the coating material may be a polymerisable liquid crystal, the solidification step comprising polymerisation of the liquid crystal layer to fix the alignment. The polymerisable liquid crystal may be thermally curable, photocurable in particular UV-curable, chemically curable or other or any combination thereof. Polymerisable liquid crystals will be preferred for many applications, and are given as examples, but the skilled person will appreciate the interchangeability with other solidification processes set out above and construe examples referring to polymerisation and curing of the LC layer accordingly.

In one embodiment of the invention a coating material exhibiting the necessary liquid crystal state is deposited on a single alignment layer. In an alternative embodiment of the invention a plurality of laterally spaced alignment layers may be used with coating material therebetween. For example two alignment layers can be used, one either side of the coating material to align the coating layer. The coating material forms a cell between the alignment layers and is then aligned therebetween. The pattern on each alignment layer in this case may be the same or different. This can be used to provide thicker layers, layers with other functionality etc.

Where a pair of alignment layers are used with a coating material therebetween the gap may be controlled by any suitable manner. This may include laying down a coating layer of controlled predetermined thickness, or using mechanical separators, such as spacer beads or embossed pillars on one or both alignment layers. An excess of coating material can then be deposited between the alignment layers and pressure applied to bring the desired space.

Where a pair of alignment layers are used with a coating material therebetween to form a cell, further means may be provided to assist in alignment of COATING material within the cell. For example electromagnetic or mechanical forces may be applied to facilitate alignment and/or further alignment layers may be provided in a multilayer laminate structure.

The arrangement of the spatially patterned periodic surface relief microstructure is determined by the application for which the patterned retarder or other optical element is to be used. For example in the case of a polarisation conversion optical system for an LCD projector it would consist of a series of stripes of width and pitch corresponding to the pitch of the polarisation splitting element. In the case of a parallax barrier for a 3D display it would correspond to a series of stripes of width and pitch determined by the pixel size in the LCD display.

The spatially patterned periodic surface relief microstructure may be made by any suitable known method. For example one or more of the following methods may be suitable: replication from a mould tool (for example embossing (UV cure and thermal), casting, injection moulding), holography, e-beam writing, laser writing, photolithography, diamond machining or mechanical ruling.

In the case of photolithography for example, a photoresist material can be exposed using a photomask that has both the required pattern for the macroscopic spatial patterning of the microstructure and the microscopic pattern for producing the microstructure itself.

The most preferred embodiment of the invention is where a replication method is used to produce the surface relief microstructure. In this preferred embodiment the first general method step comprises the two stages of first creating a mould tool comprising a spatially patterned periodic surface relief microstructure and then forming the surface relief pattern into a suitable receptive material using the said mould tool. This may be done for example by embossing (UV cure and thermal), casting or injection moulding. Preferably, a micromoulding technique is used to form the surface relief pattern.

In a particular refinement of the method, a single master is first created comprising a spatially patterned periodic surface relief microstructure and this single master is then used to prepare one or more mould tools as above described. The mould tool may be in any suitable form for the moulding process envisaged. For example a mould tool having plate geometry might be suitable. However in a preferred embodiment, especially for application to continues production processes, the mould tool is preferably in the form of a roller, and in particular preferably presents a substantially join free and fully circumferential external surface thereon.

In one alternative this is done by: forming a master pattern having a contoured metallized surface which conforms to the required relief structure, electroforming a layer of a first metal onto the metallized surface to form a metal master, releasing the metal master from the master pattern, repeating the electroforming process to form a metal embossing shim, whether a shim plate or in the preferred embodiment a join-free metal shim tube, and embossing the relief structure into a polymer film so as to provide an embossed film having the desired mould features.

One of the advantages of this route is that the complex spatially patterned periodic surface relief microstructure need only be made once as the master and then a more robust mould tool made from it by electroforming (for example in nickel) or by casting in some polymers (eg rubber), glasses or a low melting point metal. The mould tool can then be used to make many replicas. The master plate can for example be produced by one or more of the following methods: holography, e-beam writing, laser writing, photolithography, diamond machining or mechanical ruling. If desired, the master plate itself can be used as the mould tool. Surface release treatments can be applied to the mould tool to prolong its lifetime and aid release. The present invention may be used to produce a surface relief microstructure having a plurality of zones of different alignment (and hence an optical element having a plurality of such zones). Such a structure is particularly hard to produce by rubbing, since it is difficult to obtain accurate delineation of the different zones. The different zones may have differently patterned relief microstructures and/or similarly patterned relief microstructures in different orientations.

Optionally, the spatial pattern of the periodic surface relief microstructure can be produced by constructing a new master mould tool from a plurality of sub-master mould tools. Each sub-master mould tool may first be made from an unpatterned surface relief microstructure. The different alignment directions come in this case from the directions in which the sub-master pieces had been cut out and reconstructed to make the new master mould tool. This new master mould tool can be then converted into an embossing mould tool is the desired form.

The preferred replication method is by embossing the surface relief microstructure into a polymerisable polymer material, such as a photocurable polymer resin material, coated as a thin layer onto a suitable substrate. A continuous embossing process is preferred. In this preferred method a relief forming material which comprises an organic or inorganic material or precursor thereof which is polymerisable, and in particular which is curable (whether photocurable such as UV curable, thermally curable, chemically reaction curable or some combination thereof) or thermally formable is applied to a supporting first layer having a receptive surface capable of retaining the relief forming material by reaction forming or micromoulding with use of an advancing line of contact along and progressing across the surface of the supporting layer to provide a surface relief microstructured layer retained on the supporting layer. Where applicable, the surface relief microstructured layer is then cured.

In particular, the technique described in International Patent Application No W096/35971 and U.S. patent application Ser. No. 08/619,717 and applied in W098/21626, the contents of which are hereby incorporated herein by reference, is especially preferred.

Thus, the preferred method for creating the surface relief microstructure in a polymerisable polymer material on a flexible substrate comprises the steps of:
creating an embossing roller with a surface relief of the dimensions required to form the desired alignment layer surface relief microstructure, with the surface relief running around the circumference of the roller, preferably for substantially the entire circumference in join-free manner;
coating one side of a flexible substrate with a suitable polymerisable polymer material layer and contacting this layer with the embossing roller so as to transfer the alignment microrelief pattern into the polymerisable polymer layer;
polymerising the polymer material layer to form the alignment layer, preferably while in contact with the embossing roller prior to film release.

Thus, the preferred method for producing the alignment layer on a rigid or non-transparent substrate comprises the steps of:
forming a line of contact between the receptive surface and at least one mould feature formed in a flexible dispensing layer;
applying sufficient of a polymerisable polymeric material to form the relief forming polymer, to substantially fill the at least one mould feature, along the line of contact;
progressively contacting the receptive surface with the flexible dispensing layer such that the line of contact moves across the receptive surface, and sufficient of the polymer material is captured by the mould feature so as to substantially fill the mould feature;
polymerising the polymer material filling the at least one mould feature so as to form the relief microstructure; and, optionally, thereafter releasing the dispensing layer from the relief microstructured layer.

In either case, the polymerisable polymer material is preferably a resin, capable of being cured.

The advantage of this method is that the patterned retarder or other elements may be produced by a continuously running (for example sheet feeding) or reel to reel process. Thereby the process is well suited for high volume production of patterned optical retarders or other optical elements. Another advantage of this approach is the complete absence of precision lithography.

The coating material may be coated onto the surface relief microstructure to the thickness and tolerance required by a range of coating and printing methods known in the art. Preferred methods include spin coating (for single substrates), precision bead coating or techniques that precisely meter the precise coat thickness such as gravure coating.

Table 1 compares the methods of fabrication of a patterned retarder by multi-rubbing, according to European patent 0887667 (Sharp), with the method of this invention. It is clear that the new method proposed significantly reduces the number of steps of the process. A further advantage of the proposed method is that the patterned retarder elements may be produced by a continuously running or reel to reel process. Thus the process is well suited for high volume production of patterned retarder elements. Another advantage is the complete absence of precision lithography. It should also be noted that the processing tolerances are reduced compared to the prior art method.

TABLE 1
Comparison of prior art fabrication technique and process of current
invention for making patterned retarders.

| prior art process | | Process of current invention | |
|---|---|---|---|
| 1. | Coat substrate with alignment | 1. | Coat substrate with UV |
| | material | | curable resin |
| 2. | Bake alignment material | 2. | Emboss and cure surface |
| | | | relief microstructure |
| 3. | Rub in first direction | 3. | Coat with coating material |
| | | | exhibiting LC phase |
| 4. | Coat with resist | 4. | Solidify from LC phase |
| 5. | Expose resist through mask | | |
| 6. | develop resist | | |
| 7. | Rub over resist in second | | |
| | direction | | |
| 8. | Flood expose resist | | |
| 9. | Develop resist | | |
| 10. | Coat with polymerisable liquid | | |
| | crystal | | |
| 11. | Polymerise liquid crystal | | |

The supporting layer may be rigid or flexible, but is preferably flexible for application to continuously running or reel to reel processes.

The suitably receptive material may be supported on a range of substrate types including polymers (flexible and rigid) and non-polymers such as glass. The substrate may optionally be pre-coated on either side with either an anti-reflection layer (when the element is to be used in transmission) or a reflective layer.

The period of the periodic microstructure may be uniform across the relief-patterned area, may be different for different regions of the relief-patterned area, or may vary across the relief-patterned area. In any event, the period of the periodic microstructure is preferably below 5.0 μm, and more preferably below 2.0 μm. The period is preferably at least 0.1 μm and most preferably lies in the range 0.2 to 1.0 μm.

The depth of the periodic microstructure may be uniform across the relief-patterned area, or alternatively may be different for alternating stripes with different direction of grooves, or may vary across the relief-patterned area or between different zones in the relief-patterned area. In any event the depth is preferably sub-micron, preferably in the range 0.02 to 1.0 μand in particular 60 nm to 350 nm. The depth of the microstructure should be significantly less than the thickness of the coating film it is being used to align otherwise the microstructure itself will tend to have an adverse effect on the optical retardation properties of the coating film.

The cross-section shape of the periodic microstructure may be symmetric or asymmetric.

One example of a useful optical retarder element is where the macroscopic pattern comprises a series of alternating stripes or bands. Within one stripe, the microgrooves are generally parallel and oriented in a first direction at a first angle to the boundary between the stripes and within an adjacent stripe the microgrooves are generally parallel and oriented in another direction at a second angle to the boundary between the stripes. These angles may lie in the range from 0 to 90, more preferably from 15 to 45 degrees. In one embodiment, these angles are equal and opposite.

The orientation of the optical axis of the cured LC lies largely along the direction of the microgrooves of the surface relief pattern. In the simplest case therefore one can make a uniform optical retarder for use in combination with a patterned optical retarder by using a simple unpatterned monograting surface.

The suitable receptive material should also have optical and physical properties that do not affect the performance of the phase retarding optical element.

The material into which the periodic surface relief microstructure is fabricated (suitably receptive material) should be one that replicates the surface relief without significant distortion or error.

In the case where the optical retarder element is designed to operate in transmission, the suitable receptive material should have negligible birefringence (preferably less than 0.001) and should be as transparent as possible over the operating wavelength range of the element.

In the case where the optical retarder or other optical element is designed to operate in reflection, the suitable receptive material may be coated with a metal or multilayer dielectric coating so as to make it reflecting, after it has been patterned with the periodic surface relief microstructure and/or the fabricated aligned patterned coating layer may be subsequently transferred to a substrate of or coated with such material.

There may or may not be a supporting substrate for the suitable receptive material.

A range of coating techniques known in the art (for example spin, gravure, roller or K-bar coating) may be used so as to form a uniform coating of liquid crystal or other suitable coating material of known and controlled thickness on top of the periodic surface relief microstructure. The optical thickness of the coating layer, along with its birefringence, determines the physical thickness required to obtain the desired retardation of light of a certain wavelength.

The coating material may be coated from solution (for example using xylene or PGMEA as solvents) or from 100% solids using temperature to control or reduce liquid viscosity. The coating material needs to be in a liquid crystalline phase in order to align before solidification. In solution it is normally in the isotropic phase and when the solvent is removed during coating it enters a liquid crystalline phase on the surface of the microstructure.

It is desirable that immediately before alignment the layer is put into the isotropic phase to eliminate defects, unwanted ordering etc. In a preferred embodiment of the method, particularly if the coating material is not already in its isotropic phase when applied, then the coating material should be transformed (for example by heating) to an isotropic phase and back to a liquid crystalline phase prior solidification.

Such coating materials will typically be treated to produce and aligned solid layer by removal of remaining solvent and/ or by a polymerisation step, for example by application of heat. The temperature at which such a coating material is polymerised may be varied so as to fine-tune the retardation of the element since the higher the temperature the lower the birefringence and hence lower the retardation for a given thickness of liquid crystal layer.

In the case of the photopolymerisable liquid crystal RM34 (ex Merck) the liquid crystal is cured under nitrogen using a UV lamp.

A variation of the main process allows the use of two alignment substrates.
(a) the surface relief pattern is produced into a suitable receptive material as previously described.
(b) the coating material, for example being a polymerisable liquid crystal, is coated on top of the surface relief pattern.

(c) A second surface relief alignment pattern is laminated on top of the coating material.

(d) the coating material is transformed into a solid layer, for example the polymerisable liquid crystal is polymerised.

Alternatively, two alignment surfaces are produced and the coating material is metered into the gap between them. The gap may be set by the volume of liquid crystal dispensed or by the use of spacers.

A variation of the main process described above that allows the re-use of the part with the replicated surface relief is described below.
(a) the surface relief pattern is produced into a suitable receptive material as previously described.
(b) the coating material, for example being a polymerisable liquid crystal, is coated on top of the surface relief pattern.
(c) the coating material is transformed into a solid layer, for example the polymerisable liquid crystal is polymerised.
(d) a layer of adhesive is coated or laminated onto a suitable carrier substrate. Suitable carrier substrate materials are optically transparent over the wavelength range of interest and have low birefringence. For example glass, quartz or one of a range of plastic films such as those made from polyethersulphone, polycarbonate, polyarylate, cellulose diacetate, cellulose triacetate, trimethylpent-3-ene, cyclic polyolefins, or similar.
(e) The surface of the coating layer, for example the polymerisable liquid crystal film, is contacted with the adhesive layer.
(f) the suitable receptive layer and the adhesive coated carrier substrate are separated thereby transferring the coating layer, for example the polymerisable liquid crystal film layer, onto the adhesive coated layer.

In order for this process to work successfully, the polymerised liquid crystal layer must adhere more strongly to the adhesive layer than to the suitable receptive material. This is achieved by careful choice of materials for the adhesive and the receptive layers.

In a further embodiment of the invention, the method may be used repeatedly so as to build up a series of primary patterned (or uniform) retarder or other optically functional layers formed in accordance with the invention, so as to give the patterned optical element improved additional or optical functionality (for example where the optical element is an optical retarder element decreasing the variation of the retardation with wavelength). Additionally or alternatively, one or more secondary layers may be laid down in conventional manner (that is, by application of a method other than the method of the invention), again to give the patterned optical element additional or improved optical functionality. Such secondary layers are selected for desired optical or other properties and might include coloured films, reflective layers, uniform optical retarder layers or the like.

The additional retarder layers or other optically functional layers may be formed either directly on top of the polymerised liquid crystal or other coating layer or on the back of the substrate supporting the suitably receptive material. They may be formed simultaneously or sequentially. In particular, secondary layers may be formed before or after coating layers, on the top of a coating layer, on the face of the alignment layer below a subsequently formed coating layer, or on the back of the substrate supporting the suitably receptive material for the alignment layer depending on properties.

In particular, the patterned optical element preferably includes at least a further layer of reflective material, and the method comprises depositing such a layer simultaneously or sequentially with the or a coating layer.

In a further embodiment of the invention, two substrates are produced, one with the alignment microrelief structure and one with the alignment relief microstructure superimposed on a surface relief structure of a different type (for example microprisms). The two substrates are brought together and the coating material is metered into the gap between them. The gap may be set by the volume of coating material dispensed or by the use of spacers. The coating material is then transformed to a solid layer and optionally one or both of the substrates removed.

Optionally, other layers with other optical functionality may be introduced into the multilayer element described above by lamination using appropriate pressure sensitive or curing adhesives. For example a sheet of conventional uniform linear optical retarder film may be included or a sheet of dyed film to give a colour effect or to act as a colour filter.

The aligned coating layer forms the optically active element suitable for inclusion in an optical retarder device or other optical device, which can then be retained on the original substrate, transferred onto another substrate, given suitable surface treatments and/or used in conjunction with other suitable layers to form a device of desired properties.

Thus, in a further aspect, a method for the manufacture of patterned optical devices such as optical retarder devices comprises first fabricating the element according to the steps above described and then fabricating the element into a device having suitable properties. That is to say the method of this aspect of the invention comprises first forming an alignment layer comprising a spatially patterned periodic surface relief microstructure into a suitable receptive material; laying down a coating layer for example of a polymerisable liquid crystal, and in particular a curable such as a photocurable liquid crystal, onto the alignment layer enabling alignment thereof; and transforming the coating material layer to a solid film, for example by polymerising the polymerisable liquid crystal layer, to fix the alignment (that is, such that the molecular alignment between film and alignment layer is substantially preserved) so as to produce a liquid crystal element for an optical device such as an optical retarder. The method of this aspect of the invention then comprises the further step of transferring the liquid crystal or other coating material layer to a suitable secondary substrate, which may be preselected and/or subsequently coated/treated for other desired optical or other properties, and optionally the further step of removing from the element formed by the liquid crystal or other coating material layer, the alignment layer and/or any primary substrate onto which the alignment layer was previously deposited.

1. In a further aspect, the invention comprises a patterned optical element such as an optical retarder or a liquid crystal element for use in such an optical element manufactured by the foregoing method. In particular, a patterned optical element such as an optical retarder or a liquid crystal element for us in such an optical element comprises an alignment layer comprising a spatially patterned periodic surface relief microstructure fabricated from a suitable pattern-receptive material, and optionally laid down upon a supporting substrate; and an optically active coating layer of aligned material, such as polymerised liquid crystal material, solidified from a liquid crystal phase such that a molecular alignment between the coating layer and alignment layer established during the said liquid crystal phase is substantially preserved.

Preferred features of these further aspects of the invention, and in particular of the material, and of the fabrication and structure of the surface relief microstructure, will be understood by analogy with the foregoing.

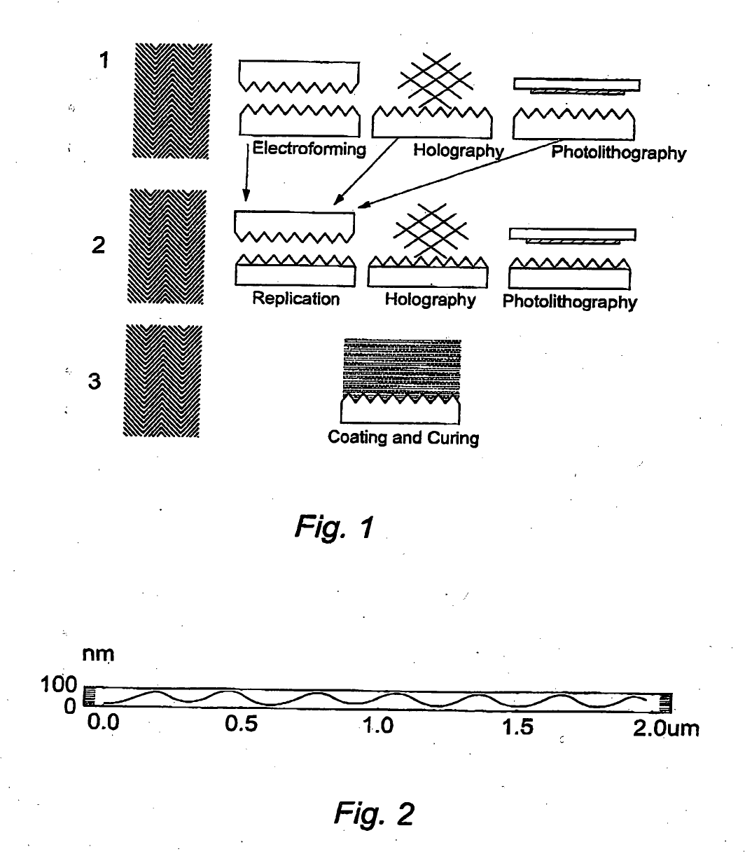

The invention will now be described by way of illustration in the form of certain examples and with reference to FIGS. 1 to 6 of the accompanying drawings in which:

FIG. 1 illustrates an embodiment of the inventive process to produce a patterned retarder element;

FIG. 2 illustrates a surface profile of an example grating for use in the method of the invention;

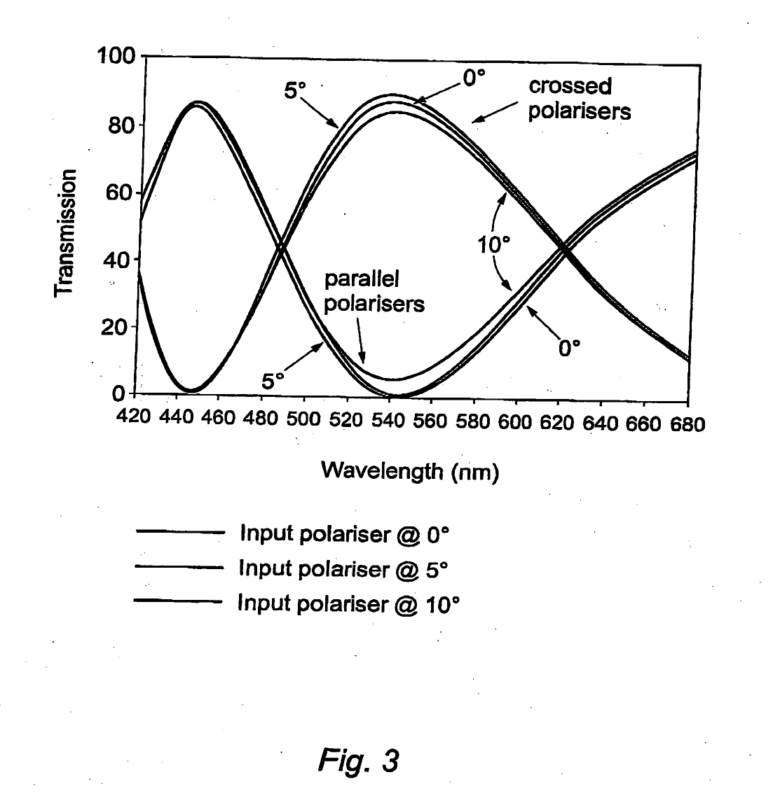

FIG. 3 shows transmission data for optical retarder;

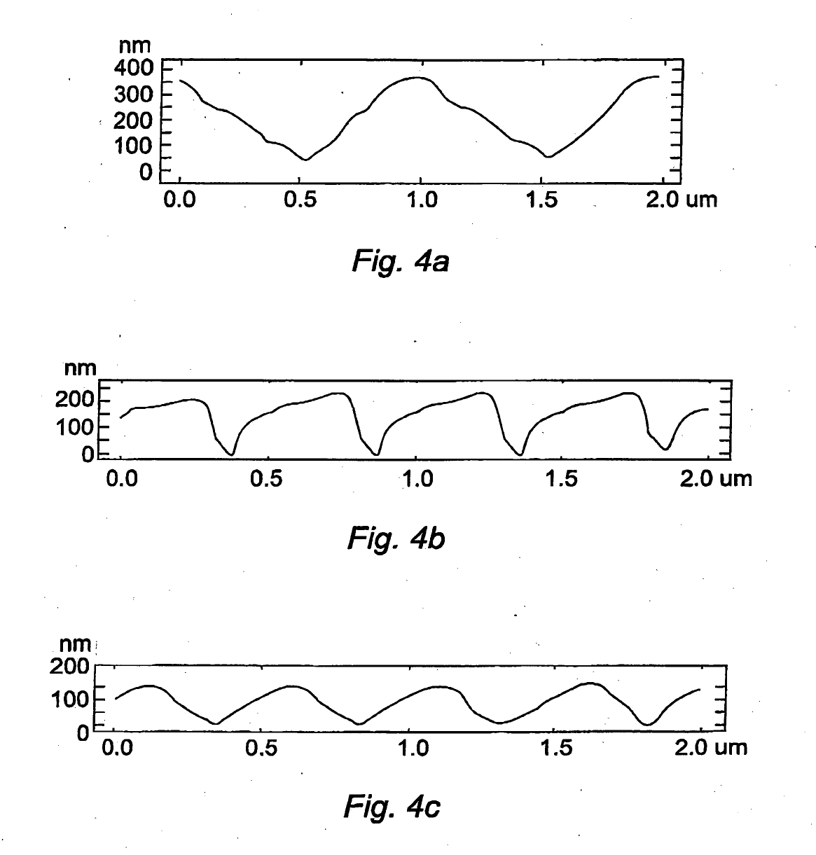

FIG. 4 shows surface relief profiles for an example device;

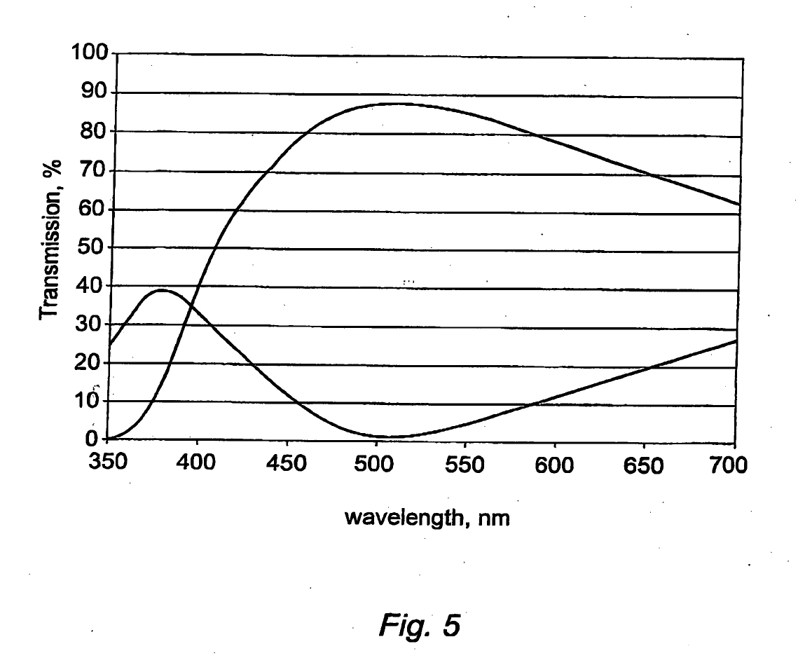

FIG. 5 shows a transmission spectrum for an example device;

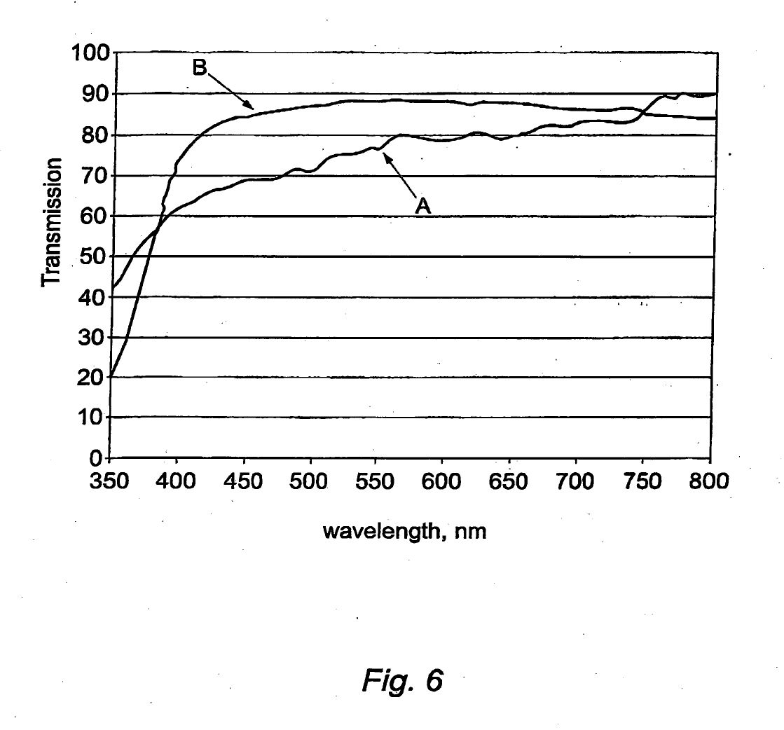

FIG. 6 shows a transmission spectrum for an example device.

FIG. 1 illustrates an embodiment of the inventive process to produce a patterned retarder element. Optional step 1 is to make a mould tool, step 2 is to produce the surface relief pattern in a suitable material by suitable means, step 3 is to coat and cure the polymerisable liquid crystal to lock in the alignment and orientation of the liquid crystal. Examples of suitable material combinations follow.

### EXAMPLE 1

This example describes the fabrication of a phase retarding optical element by means of the improved process described in the main text of the patent.

A monograting surface relief profile was manufactured on the surface of a nickel-plated roller by means of single point diamond turning. The surface profile of the resultant grating was recorded by atomic force microscopy (AFM) and is shown in FIG. 2.

The period of the grating was 0.3 μm and the depth of the grating was 60 nm. The roller was used to make a flexible mould tool by coating a 175 μm thick PET film (Melinex grade 505) with specially formulated UV curable acrylate resin and embossing the surface relief grating from the roller into the UV cured acrylate resin. The UV embossing was carried out as described in WO96/35971 at a speed of 0.5 m/min and nip pressure of 2.5 bar. The resin was cured with a UV lamp system using a fluence of approximately 180 J/cm² at a peak output wavelength of 365 nm. The thickness of the embossed cured resin layer on the PET film was 3 μm.

Using the same process as for the fabrication of the flexible mould tool, the flexible mould tool was used to UV emboss the surface relief grating into a coating of a second UV curable acrylate resin (the suitable receptive material) on a glass plate. The thickness of the embossed cured resin layer on the glass was 3 μm.

The resultant part was spin coated using a 40% by weight solution of photocurable liquid crystal RM34 (ex Merck) in xylene. The spin speed used was 2350 rpm with a dwell time of 30 s. This spin speed was chosen so as to give a cured film thickness that acts as a half wave plate for light with a wavelength of 550 nm. Since the difference in refractive index between the ordinary and extraordinary rays in the aligned and cured LC film was measured to be 0.1545 at 590 nm, the required thickness of the RM film in this case is 1.8 μm. The coated RM film was cured under nitrogen at 20° C. using a UV lamp with a power output of 1 mW/cm² for 20 min.

The finished optical part was tested by recording the transmission as a function of wavelength between parallel polarisers. The transmission was found to fall to a minimum of approximately 1% at a wavelength of 550 nm, indicating that the RM34 layer was aligned and acting as a half wave plate (see FIG. 3 which plots transmission (in %) of optical retarder part between polarisers as a function of wavelength to show the minimum at 550 nm).

### EXAMPLE 2

This example describes the fabrication of a phase retarding optical element using a surface relief grating of different shape and amplitude to example 1.

An optically recorded reflective monograting was obtained from Spectragon UK Ltd, Glenrothes, Fife. The grating was specified as 3300 lines/mm (0.3 μm pitch). The grating was specified for operation in the visible (400 to 700 nm). AFM analysis of the grating showed it to be nearly sinusoidal in shape with a depth of 80 nm. A nickel embossing shim was grown by electroforming from this master plate. AFM analysis of the nickel shim showed that the grating profile had been replicated with no change in the pitch and a small reduction in the depth to between 62 and 65 μm. The nickel embossing shim was used to make a flexible mould tool by coating a 175 μm thick PET film (Melinex grade 505) with specially formulated UV curable acrylate resin and embossing the surface relief grating from the nickel shim into the UV cured acrylate resin. The UV embossing was carried out as described in WO96/35971 at a speed of 0.5 m/min and nip pressure of 2.5 bar. The resin was cured with a UV lamp system using a fluence of approximately 180 J/cm² at a peak output wavelength of 365 nm. The thickness of the embossed cured resin layer on the PET film was 3 μm.

Using the same process as for the fabrication of the flexible mould tool, the flexible mould tool was used to UV emboss the surface relief grating into a coating of a second UV curable acrylate resin (the suitable receptive material) on a glass plate. The thickness of the embossed cured resin layer on the glass was 3 μm.

The resultant part was spin coated using a 40% by weight solution of photocurable liquid crystal RM34 (ex Merck) in xylene. The spin speed used was 1600 rpm with a dwell time of 40 s. This spin speed was chosen so as to give a cured film thickness that acts as a half wave plate for light with a wavelength of 575 nm. Since the difference in refractive index between the ordinary and extraordinary rays in the aligned and cured LC film was measured to be 0.1545 at 590 nm, the required thickness of the RM film in this case is 1.86 μm. The coated RM film was cured under nitrogen at 20° C. using the same UV lamp as for the embossing but with a fluence of 18 J/cm².

The performance of the resulting optical retarder part was tested by placing it between parallel polarisers and measuring the transmission as a function of wavelength. The transmission was found to fall to 1% at a wavelength of 575 nm. This indicates that the liquid crystal film has been oriented by the surface relief grating.

### EXAMPLE 3

This example describes the fabrication of a phase retarding optical element using a surface relief grating of different period to example 1 and 2.

The procedure of example 2 was repeated except using a grating specified as 2400 lines/nm (0.4 μm pitch). The grating was specified for operation in the visible (400 to 700 nm). The measured optical performance of the half wave plate was very similar to that of example 2.

### EXAMPLE 4

This example describes the fabrication of a phase retarding optical element using the transfer process described in the text. Also this example shows how elements can be successfully made using surface relief gratings of different pitch, amplitude and shape.

A series of three monograting-type surface relief patterns were fabricated by diamond machining into the surface of nickel coated rollers. The shape of the tool and the pitch of the pattern were varied. The resultant surface relief profiles was recorded by AFM and are shown in FIGS. 4 a, b and c, respectively illustrating a saw tooth surface relief profile with 1 μm pitch and depth of 350 nm; an asymmetric saw tooth surface relief profile with 0.5 μm pitch and depth of 120 nm; and a saw tooth surface relief profile with 0.5μm pitch and depth of 180 nm.

Each of these rollers in turn was taken and used to make a flexible mould tool by coating a 100 μm thick PET film (Melinex grade 505) with specially formulated UV curable acrylate resin and embossing the surface relief grating from the roller into the UV cured acrylate resin. The UV embossing was carried out as described in WO96/35971 at a speed of 0.5 m/min and nip pressure of 2 bar. The resin was cured with a UV lamp system using a fluence of approximately 180 J/cm² at a peak output wavelength of 365 nm. The thickness of the embossed cured resin layer on the PET film was 3 μm.

The resultant parts were spin coated using a 40 weight % solution of photocurable liquid crystal RM34 (ex Merck) in xylene. The spin speed used was 2350 rpm with a dwell time of 30 s. This spin speed was chosen so as to give a cured film thickness that acts as a half wave plate for light with a wavelength between 450 and 550 nm. Since the difference in refractive index between the ordinary and extraordinary rays in the aligned and cured LC film was measured to be 0.1545 at 590 nm, the required thickness of the RM film in this case is between 1.5 and 1.9 μm. The coated RM film was cured under nitrogen at 20° C. using a UV lamp with a power output of 1 mW/cm² for 20 min.

A layer of UV curing acrylate resin adhesive was coated on top of the cured liquid crystal film by spin coating. Spin speed was 3000 rpm and dwell time was 30 s. The thickness of the adhesive film layer was 16 μm. The adhesive coated film was laminated at room temperature onto a 1.1 mm thick borosilicate glass plate by passing the film and glass through a nip between two rollers. A nip pressure of 4 bar was used. The adhesive layer was cured by placing the laminated part under a UV lamp with a power output of 1 mW/cm² for 15 min. Finally, the PET film was peeled off to leave the cured and aligned liquid crystal film on the surface of the glass.

The finished optical parts were tested by recording the transmission as a function of wavelength between parallel polarisers. All three different gratings caused alignment of the liquid crystal film, as evidenced by the presence of a transmission minimum between parallel polarisers in the wavelength range 450 to 550 nm. FIG. 5 shows for example the transmission spectrum of the sample obtained from grating (c). The figure plots transmission vs wavelength of sample between crossed (upper curve) and parallel (lower curve) polarisers. The angle of the input polariser was adjusted relative to the output polariser by 10 degree in both cases to obtain the maximum and minimum transmission respectively.

### EXAMPLE 5

This example shows the effect of coating the finished part with an index-matching matching layer so as to reduce the effect of optical diffraction when the grating pitch is larger than 0.4 μnm.

The three samples prepared in example 4 were taken and a UV-cured coating of Norland 61 was spin coated onto them so as to reduce the effect of diffraction from the surface relief grating used to align the liquid crystal film. The refractive index of this material is 1.56 (between the indices of the o and e-rays, 1.54 and 1.69 respectively). FIG. 6 shows the spectra obtained prior to coating of the Norland 61 onto the sample from grating (c) and afterwards (i.e. with (curve B) and without (curve A) index matching resin). The transmission in the blue part of the spectrum has been significantly increased by the index matching film. The effect is most noticeable for the 1 μm period grating since its diffraction efficiency is highest in this part of the spectrum.

1: A method for the manufacture of a patterned optical element comprising the steps of:
forming an alignment layer comprising a spatially patterned periodic surface relief microstructure formed into a suitable receptive material;
laying down a coating material that exhibits a liquid crystal phase onto the alignment layer enabling alignment of the coating material with the microstructure of the alignment layer;
forming the coating material into a solid film such that the molecular alignment between film and alignment layer is substantially preserved.

2: The method of claim 1 wherein the coating material is a lyotropic liquid crystal and the solid film forming step comprises removal of solvent to such point that a solid phase is formed from the coating layer.

3: The method of claim 1 wherein the coating material is a polymerisable liquid crystal and the solid film forming step comprises polymerisation of the liquid crystal layer.

4: The method of claim 3 wherein the polymerisable liquid crystal is photocurable and the polymerisation step comprises the step of photocuring the liquid crystal layer.

5: The method of claim 4 wherein the photocurable liquid crystal is UV-curable and the polymerisation step comprises the step of UV-photocuring the liquid crystal layer.

6: The method of claim 1 wherein the surface relief microstructure is deposited on or integrally formed as part of a suitable supporting substrate, the coating material being deposited thereupon to form an aligned layer such that the substrate comprises a suitable substrate for a device or a part thereof created by formation of the aligned layer.

7: The method of claim 1 wherein the surface relief microstructure is deposited on or integrally formed as part of a suitable fabrication substrate the coating material being deposited thereupon to form an aligned layer, which aligned layer is subsequently transferred from the fabrication substrate to a second substrate comprising a suitable support substrate for a device or a part thereof comprising the aligned layer.

8: The method of claim 1 wherein a coating material is deposited on a single alignment layer.

9: The method of claim 1 wherein a plurality of laterally spaced alignment layers are used and coating material is deposited and solidified therebetween.

10: The method of claim 8 wherein two alignment layers are used, one either side of the coating material to align the coating material.

11: The method of claim 1 wherein the spatially patterned monograting-like surface relief microstructure is first fabricated by photolithography in that a photoresist material is exposed using a photomask that has both the required pattern for the macroscopic spatial patterning of the microstructure and the microscopic pattern for producing the microstructure itself.

12: The method of claim 1 wherein a replication method is used to produce the surface relief microstructure.

13: The method of claim 12 wherein the surface relief microstructure is prepared by a two stage process of first creating a mould tool comprising a spatially patterned monograting-like surface relief microstructure and then forming the surface relief pattern into a suitable receptive material using the said mould tool.

14: The method of claim 13 wherein a single master is first created comprising a spatially patterned monograting-like surface relief microstructure and this single master is then used to prepare one or more of the said mould tools.

15: The method of claim 14 wherein the surface relief microstructure is prepared by first forming a master pattern having a contoured metallized surface which conforms to the required relief structure, electroforming a layer of a first metal onto the metallized surface to form a metal master, releasing the metal master from the master pattern, repeating the electroforming process to form a metal embossing shim, whether a shim plate or in the preferred embodiment a join-free metal shim tube, and embossing the relief structure into a polymer film so as to provide an embossed film having the desired mould features.

16: The method of claim 12 wherein the replication method comprises embossing the surface relief microstructure into a coating material, such as a photocurable polymer resin material, coated as a thin layer onto a suitable substrate.

17: The method of claim 16 wherein the replication method is a continuous embossing process wherein a relief forming material which comprises an organic or inorganic material or precursor thereof which is polymerisable, and in particular which is curable or thermally formable is applied to a supporting first layer having a receptive surface capable of retaining the relief forming material by reaction forming or micromoulding with use of an advancing line of contact along and progressing across the surface of the supporting layer to provide a surface relief microstructured layer retained on the supporting layer.

18: The method of claim 1 wherein the periodic microstructure is formed with a period below 5.0 μm.

19: The method of claim 17 wherein the periodic microstructure is formed with a period in the range 0.2 to 1.0 μm.

20: The method of claim 1 wherein the period is non-uniform across the relief-patterned area, being different for different regions of the relief-patterned area and/or varying across the relief-patterned area.

21: The method of claim 1 wherein the periodic microstructure is formed with a sub-micron depth.

22: The method of claim 20 wherein the periodic microstructure is formed with a depth in the range 60 to 350 nm.

23: The method of claim 1 wherein the depth is non-uniform across the relief-patterned area, being different with different direction of grooves, for different regions of the relief-patterned area and/or varying across the relief-patterned area.

24: A method for the manufacture of patterned optical elements comprising the method of claim 1 used repeatedly so as to build up a series of optically functional layers so as to give the patterned optical element additional optical functionality.

25: A method for the manufacture of patterned optical elements comprising the method of claim 1 and further comprising simultaneously or sequentially forming one or more secondary layers to give the patterned optical element additional optical functionality.

26: A method for the manufacture of patterned optical elements in accordance with claim 25 comprising depositing a reflective layer simultaneously or sequentially with the or a coating layer.

27: A patterned optical element manufactured by the method of claim 1.

28: A patterned optical element comprising a spatially patterned periodic surface relief microstructure fabricated from a suitable pattern-receptive material, and optionally laid down upon a supporting substrate; and an optically active coating layer of aligned material solidified from a liquid crystal phase such that a molecular alignment between the coating layer and alignment layer established during the said liquid crystal phase is substantially preserved.

29: A method for the manufacture of a patterned optical element or a patterned optical element substantially as hereinbefore described with reference to the accompanying drawings.
